(19) United States
(12) Patent Application Publication
(10) Pub. No.: US 2019/0114121 A1
(43) Pub. Date: Apr. 18, 2019

(54) PRINT DEVICE, PRODUCTION METHOD OF PRINTED MATTER, AND CONTROL PROGRAM

(71) Applicant: SEIKO EPSON CORPORATION, Tokyo (JP)

(72) Inventor: Hiroaki NAKANISHI, Shiojiri (JP)

(21) Appl. No.: 16/161,311

(22) Filed: Oct. 16, 2018

(30) Foreign Application Priority Data
Oct. 18, 2017 (JP) 2017-201617
Oct. 18, 2017 (JP) 2017-201618

(51) Int. Cl. G06F 3/12; G06K 15/00; G06K 15/02

(52) U.S. Cl. CPC G06F 3/1235; G06F 3/1204; G06K 15/4085; G06F 3/1263; G06F 3/1267; G06F 3/121; G06F 3/1208; G06K 15/1856

(57) ABSTRACT

A print device includes a storage unit that stores feature of a print medium and print data of a page to be printed on the print medium in association with each other, a reading unit that generates medium image data by reading the print medium which is already printed before interrupt of printing after the interrupt, a setting unit that sets a print restart page based on the feature of the print medium and the medium image data, and a print unit that performs printing based on the print data after the print restart page after resolving a cause of the interrupt of printing.

### BACKGROUND

### 1. Technical Field

The present invention relates to a print device, a production method of a printed matter, and a control program.

### 2. Related Art

In the related art, a technology for easily performing the restart of printing after the occurrence of paper jam (print medium jam) is proposed (for example, JP-A-2012-192672).

However, for example, in a case of a configuration in which a user inputs the print restart page after the occurrence of print medium jam, it is necessary for the user to grasp what page of print data in a print medium is printed before the occurrence of the print medium jam (for example, by checking contents printed on print medium). In addition, in a case of making an input mistake when the user inputs the number of a print restart page, the printing is restarted at a page other than a print restart page is originally restarted.

### SUMMARY

The present invention is to easily perform the restart of printing from a page on which printing is restarted.

According to an aspect of the invention, there is provided a print device including a storage unit that stores feature of a print medium and print data of a page to be printed on the print medium in association with each other, a reading unit that generates medium image data by reading the print medium which is already printed before interrupt of printing after the interrupt, a setting unit that sets a print restart page based on the feature of the print medium and the medium image data and a print unit that performs printing based on the print data after the print restart page after resolving a cause of the interrupt of printing.

That is, since the present invention is configured to set the print restart page based on the medium image data and the feature of the print medium, it is not necessary for the user to perform an operation such as the check of the content of the print medium already printed before the interrupt of printing or the like. In addition, in comparison with a case where the user inputs the number of the print restart page, it is possible to prevent failure to restart printing due to number input error. Therefore, according to the present invention, it is possible to easily perform print restart from a page on which printing is to be restarted.

Furthermore, in the print device, a configuration may be adopted in which the print device further includes an extraction unit that extracts feature of the print data of a page printed on a first surface of a predetermined print medium and stores the feature and the print data of a page in association with each other to be printed on the second surface of the predetermined print medium.

That is, in a case of the present configuration, the feature of the print data of the page printed on the first surface of the predetermined print medium is associated with the print data of the page to be printed on the second surface of the predetermined print medium in advance and an associated result is stored. Therefore, by reading the first surface (first surface is already printed) of the print medium, on which printing is to be restarted, by the user in the print device, the print device can specify the print data of the page to be printed on the second surface of the print medium. Therefore, the print device can reprint the page as the print restart page from the second surface of the print medium.

Furthermore, in the print device, a configuration may be adopted in which the reading unit performs reading in accordance with the feature of the print medium under a read condition.

In this case, it is possible to appropriately perform reading in accordance with the feature of the print medium.

Furthermore, in the print device, a configuration may be adopted in which the reading unit reads a region in consideration of rotation of the medium image data which is a part of the print medium, according to the feature of the print medium.

In this case, in comparison with a configuration in which the entire reading surface of the print medium is read, it is possible to reduce a time required for reading.

Also, the present invention is satisfied as an invention of a production method of a printed matter generated by the above-described print device. In addition, the present invention is satisfied as an invention of a control program causing the above-described function to be realized in a computer. In addition, functions of respective units according to aspects are realized by a hardware resource whose function is specified by the configuration itself, a hardware resource whose function is specified by a program, or a combination thereof. In addition, the functions of these units are not limited to those realized by physically independent hardware resources.

### BRIEF DESCRIPTION OF THE DRAWINGS

The invention will be described with reference to the accompanying drawings, wherein like numbers reference like elements.

FIG. 1 is a block diagram of a print device.

FIG. 2 is a diagram illustrating an example of print management information.

FIG. 3 is a diagram illustrating an example of a feature and a printing order of print data.

FIGS. 4A and 4B are a flowchart illustrating a print control process according to a first embodiment.

FIG. 5 is a diagram illustrating an example of screen transition.

FIG. 6 is a diagram illustrating another example of the screen transition.

### DESCRIPTION OF EXEMPLARY EMBODIMENTS

Hereinafter, embodiments of the present invention will be described with reference to the accompanying drawings. In the respective drawings, the same reference numerals are given to the corresponding constituent elements, and duplicate explanation is omitted.

### 1. First Embodiment

### 1-1. Configuration

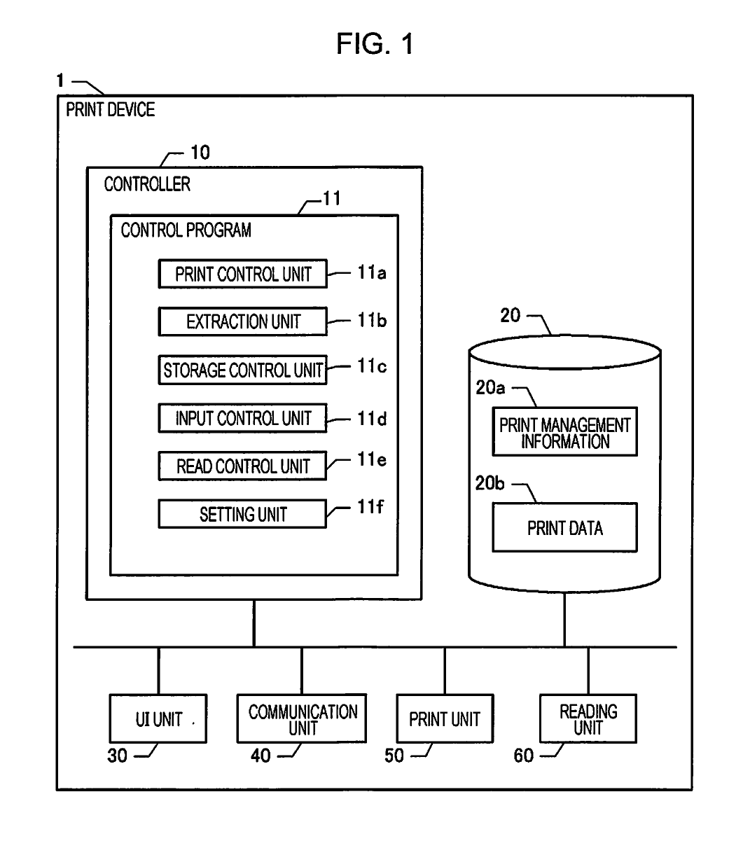

FIG. 1 is a block diagram illustrating a configuration of a print device 1 according to an embodiment of the present invention. The print device 1 having an image reading function includes a controller 10, a storage unit 20, a UI (user interface) unit 30, a communication unit 40, a print unit 50, and a reading unit 60.

The communication unit 40 includes a communication interface circuit to be connected to the Internet in a wired or wireless manner and communicating with other devices in accordance with various communication protocols via the Internet. In addition, the communication unit 40 includes various removable memories mounted on the print device 1 and an interface circuit for communicating with a device connected to the print device 1 in a wired or wireless manner.

The print unit 50 includes an actuator, a sensor, a driving circuit, and a mechanical component to perform printing on various print media with well-known printing methods such as an inkjet method and an electrophotographic method. In the sensor, a sensor that measures various states of the print unit 50 such as print medium jam, the remaining amount of the print medium, the remaining amount of recording agents, and opening and closing of a cover portion of a housing is included. The sensor for detecting the print medium jam is hereinafter referred to as a jam sensor. The print unit 50 notifies the controller 10 of an error in the print unit 50 detected based on output of this sensor.

The reading unit 60 includes a well-known color image sensor or light source that emits light to a document placed on a document platen and receives reflected light from the document to obtain scan data, an actuator for transporting the document, a drive circuit, a sensor, and a machine component. The reading unit 60 may include an ADF.

The UI unit 30 includes a touch panel type display or a key input unit. The display includes a display panel and a touch detection panel overlapped with the display panel. The display displays various types of information in accordance with the control of the controller 10 on the display panel. In addition, the display detects contact by a human finger on a touch detection panel, and outputs contact coordinates to the controller 10. The key input unit detects an operation on a key such as a power source button and outputs key operation information indicating an operated key to the controller 10. The controller 10 can obtain user's operation contents on the touch panel type display and the key input unit based on the information obtained from the UI unit 30, and perform a process on the operation contents.

The controller 10 includes a processor (CPU, ASIC, combination of these processors, or the like) (not illustrated), ROM, RAM, and the like, and controls each unit of the print device 1 by executing various programs recorded in the storage unit 20 by the processor. The storage unit 20 is implemented by one of ROM, RAM, HDD, and the like or combination thereof. In the various programs executed by the controller 10, a control program 11 is included. In this embodiment, the control program 11 causes a print restart function or a reprint function after occurrence of the print medium jam to be realized in the controller 10. The print restart function is a function for restarting printing from the print medium (print medium to which damage is not affected) next to the print medium affected by damage due to the print medium jam. The reprint function is a function for reprinting print data to be printed on the print medium to which the damage is affected due to the print medium jam on the newly replaced print medium. The control program 11 for realizing these functions includes a print control unit 11a, an extraction unit 11b, a storage control unit 11c, an input control unit 11d, a read control unit lie, and a setting unit 11f.

The print control unit 11a is a program module for realizing a function for performing printing on the print medium by controlling the print unit 50, on the controller 10. In addition, the storage control unit 11c is a program module for causing a function for storing the print data 20b to be printed on the print medium in the storage unit 20 to be realized in the controller 10. For example, the controller 10 acquires the print data 20b from a communicable PC or the like and stores the acquired result in the storage unit 20 via the communication unit 40 by a process of the storage control unit 11c. The controller 10 performs printing on the print medium based on the print data 20b by a process of the print control unit 11a.

The extraction unit 11b is a program module for extracting the feature of print data of a page to be printed on the first surface of a predetermined print medium, and realizing a function for storing the feature of the print data of the page and the print data of a page to be printed on the second surface of the predetermined print medium in association with each other in the storage unit 20, in the controller 10. In this embodiment, the feature extracted from the print data to be printed on the print medium corresponds to the “feature of the print medium”.

In this embodiment, it is assumed that duplex printing (manual duplex printing) on the print media is performed in multiple sheets. In a case where the duplex printing on the print medium corresponding to automatic duplex printing is performed on n sheets (n is natural number), the second surface of the first sheet is printed after printing of the first surface of the first sheet, and the same printing is performed from the second sheet to the n-th sheet. Meanwhile, in a case where the duplex printing with respect to the print medium not corresponding to the automatic duplex printing is performed in n sheets in the manual duplex printing, after printing on the first surface of each print medium in n sheets, printing on n sheets is performed on the second surface. n sheets of the print media in which the first surface is printed, are stacked on a paper discharge unit in a state where the first surface is directed in the above (n-th print medium is in top). An operation where n sheets of the print media in which the first surface is printed, is taken from the paper discharge unit, is collectively turned over, and moves to a paper feed unit (paper feed unit of which top side is print side), is performed by a user. n sheets of the print media placed in the paper feed unit is in a state where the second surface is on the upper side (the first print medium is on top side). After completing printing of the first surface in n sheets, by placing the print medium on the paper feed unit, it is possible to perform printing the second surface of the medium from the first print medium to the n-th print medium.

The description of the above-described order of the manual duplex printing and the top and bottom surfaces of the print medium is an example, and the manual duplex printing may be performed in a mode other than the above-described description.

In the printed matter of multiple sheets to be produced by a batch process by the manual duplex printing, in a case where the print content of the first surface and the print content of the second surface are determined for each print medium, it is necessary to perform the printing so that one of the contents to be printed on the first surface and the second surface of the same print medium is not printed on another print medium. For example, in a case where insurance policies including unique information corresponding to security numbers are printed on both front and back sides, information printed on the front and back sides of the print medium may be information corresponding to the same security number.

Here, a case is considered where the print medium jam occurs while performing the manual duplex printing. For example, in a case where the print medium jam occurs while printing on the first surface of n sheets of the print media is completed and the printing on the second surface is performed, the user restarts printing after removing a print medium damaged due to the print medium jam. The print medium damaged due to the print medium jam can be assumed to be a jammed print medium, the print medium already supplied to a transport path when the print medium jam occurs, or the like. The jammed print medium may be one sheet or may be multiple sheets. The jammed print medium is damaged by dust and tears or wrinkles when the user removes the medium. In addition, for the print medium already supplied to the transport path when the print medium jam occurs, when removing it from the transport path, it may be applied or not be applied by the above damage. Therefore, the number of sheets of the print medium to which the damage is applied due to the print medium jam may vary depending on conditions. In addition, a print device side cannot automatically and accurately grasp the number of sheets, which may vary depending on the conditions.

The number of sheets of the damaged print media may vary, but it is necessary to restart printing from the printing of the print data of a page corresponding to the print data of a page already printed on the first surface of the print medium on which printing is restarted at the time of restarting printing on the second surface. In addition, for one print medium or more to which the damage is applied, it is necessary to accurately specify the print data of the page supposed to be printed on the print medium and to perform (reprint) the printing based on the print data of the newly exchanged print medium.

In order to prepare the case, in a case of performing the manual duplex printing on n sheets of the print media, the controller 10 stores the feature of the print data of a page to be printed on the first surface of the i-th print medium (i is integer satisfying 1≤i≤n) and the print data of the page to be printed on the second surface of the i-th print medium in association with each other in the storage unit 20.

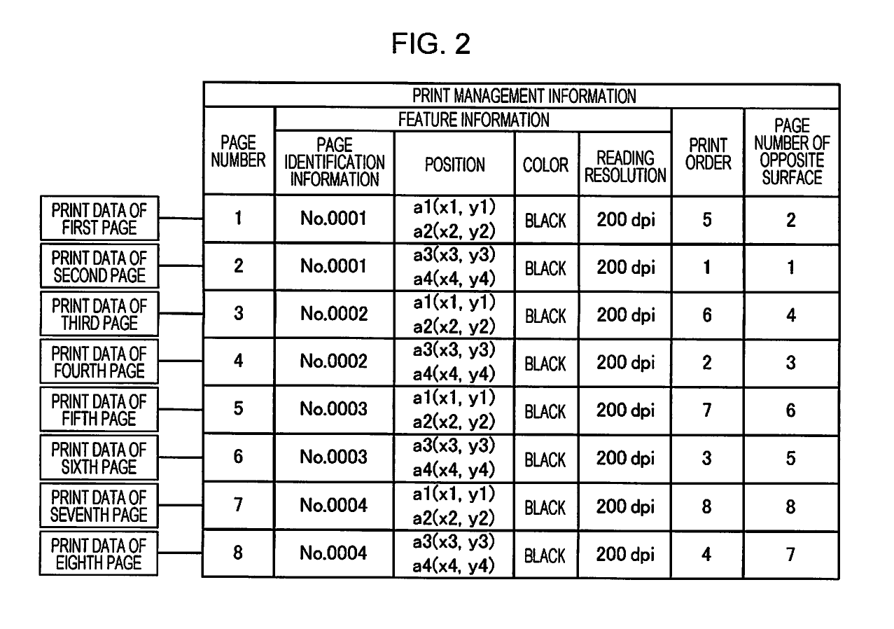

FIG. 2 a diagram illustrating an example of print management information 20a created by the controller 10 in a case of performing the manual duplex printing. In this embodiment, as illustrated in FIG. 2, it is assumed that eight pages of the print data is printed on both front and back sides of four sheets of the print medium (n=4). A table may be formed on either the first surface or the second surface. A page of which the page number is j, is referred to as the “j-th page” (j is integer satisfying 1≤j≤8). FIG. 2 illustrates that the print data of the j-th page, “feature information” extracted from the print data of the j-th page, a “print order” of the print data of the j-th page, and the “page number of the opposite side” of the j-th page are associated and stored. The “page number of the opposite side” of the j-th page indicates the page number printed on the other surface of the print medium on which the print data of the j-th page is printed on one surface.

For example, for a page of which the “page number” is “1” of FIG. 2, print data of the first page, “feature information” extracted from the print data of the first page, the “print order” of the print data of the first page, and “2” as the “page number of the opposite side” of the first page are associated and stored. That is, this indicates that the print data of the first page is the print data of the second page of printed on the other surface of the print medium printed on the one surface. For a page of which the “page number” is “2”, the print data of the second page, the “feature information” extracted from the print data of the second page, and “1” as the “page number of the opposite side” of the second page are associated and stored. Therefore, the feature of the print data of a page printed on the first surface of the i-th print medium is associated with the print data of the page to be printed on the second surface of the i-th print medium and the associated result is stored in the storage unit 20.

In this embodiment, in the feature information, “page identification information”, a “position” on which the page identification information is printed, a “color” on which the page identification information is printed, and a “reading resolution” for reading the page identification information are included. In this embodiment, since the combination of the “page identification information”, the “position”, and the “color” is extracted for each page by the extraction unit 11b, the page can be identified by the combination. The “page identification information” is one piece of information for identifying the page, and may be characters, graphics, or the like printed on each surface of the print medium. Specifically, for example, the “page identification information” includes a specific character, a predetermined character (which may include number or symbol) following the specific character, and may include a barcode, a two-dimensional code, or the like. The specific character may be designated in advance by the user. Multiple pieces of the “page identification information” may be present per page, and, in this case, the “position” is may be stored in each “page identification information”.

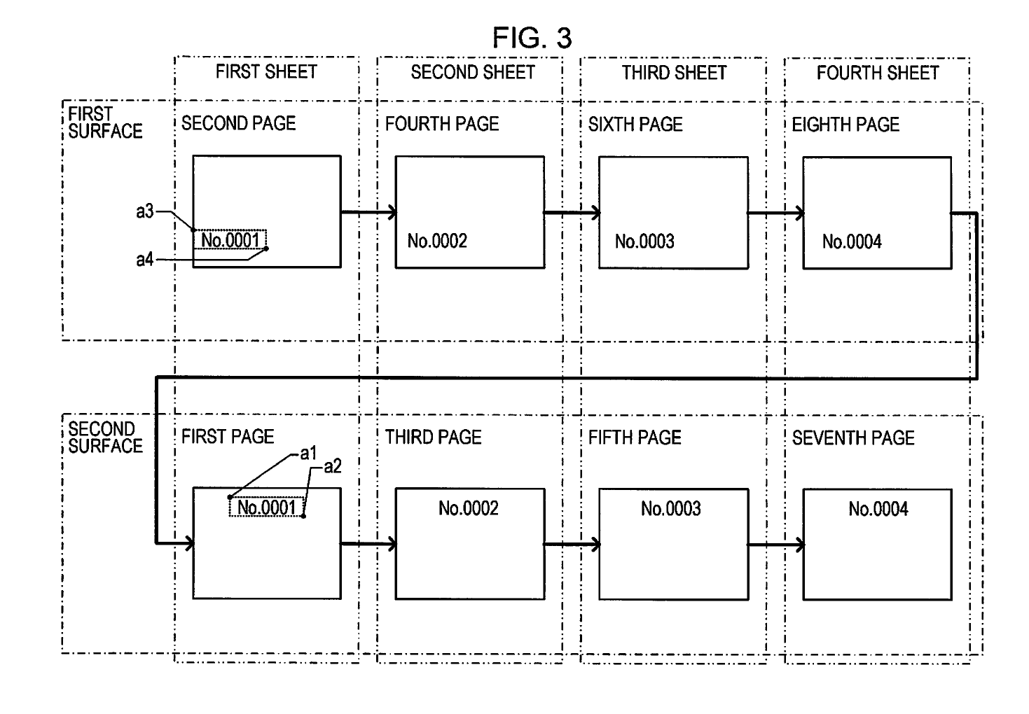

FIG. 3 is a schematic diagram illustrating the feature and the printing order of the print data in this embodiment. In FIG. 3, the print data of the (i×2)-th page is printed on the first surface of the i-th print medium (1≤i≤4), and the print data of the ((i×2)−1)-th page is printed on the second surface of the i-th print medium.

The reading resolution may be any resolution that is necessary and sufficient for reading the page identification information, and, for example, the reading resolution is the same as the print resolution designated at the time of manual duplex printing setting of the print data 20b, or about a half of the print resolution. In addition, for example, the page identification information may be set according to the content of the page identification information such that the reading resolution is made finer if the page identification information is a small character string and the reading resolution is made rough if the page identification information is a large character string.

For example, these pieces of the feature information are extracted by the controller 10 during a time from user's selection of the manual duplex printing of the print data 20b to the restart of printing actually, and the extracted results are stored in the storage unit 20 in an associated state as illustrated in FIG. 2. The feature information illustrated in FIG. 2 may be configured to start printing after all pages are created. Alternately, the feature information may be configured to perform the printing while creating the feature information in an order from the first page in the print order (printing of j-th page is performed by extracting feature information of print data of j-th page). The feature information may be extracted while generating the print data 20b.

For example, the “page identification information”, the “position”, and the “color” can be extracted from the print data (print data after rendering) of each page. Specifically, a configuration may be adopted in which, for example, the print data is compared between respective pages, a region in which an image (including character image) different from a predetermined margin or more for each page is drawn is specified, the image included in the region is extracted as the “page identification information”, the position of the regions is extracted as the “position”, and the color of the image is extracted as the “color”. In addition, a configuration may be adopted in which, for example, regarding the extraction of the page identification information, the character string designated by the user is specified in a region designated in advance by the user in the print data and a character following the character string is extracted as the page identification information. In addition, a configuration may be adopted in which, for example, these pieces of the information is extracted by analyzing XML in a case of an XML format of the print data.

In examples illustrated in FIG. 2 and FIG. 3, it is indicated that the same identification information is printed at different positions in the page on the first surface and the second surface of the i-th print medium. For example, the “position” is stored as the coordinates of the diagonal point of a rectangular region on which the identification information is printed as illustrated in the same diagram.

The input control unit 11d is a program module for causing the controller 10 to realize a function for urging the input of first information for identifying the last print medium (first print medium) which can be normally printed before the occurrence of the print medium jam and the input of second information for identifying the print medium (second print medium) next to the print medium damaged due to the print medium jam to the user. In this embodiment, the controller 10 causes the user to be urged through the UI unit 30 to input a read start instruction by placing the first print medium on the document platen of the reading unit 60 by a process of the input control unit 11d such that the first print medium of which a surface already printed is a reading surface (corresponding to urging of input of first information). Therefore, in this embodiment, the reading unit 60 and the UI unit 30 correspond to the input unit. In this embodiment, the controller 10 causes the later printed surface not the previously printed surface to be the reading surface in a case where the duplex printing is already printed on the first print medium. According to this guidance, the user can instruct the remove of the most newly discharged print medium (first print medium) among the print media already discharged from the paper discharge unit of the print unit 50 from the paper discharge unit, and reading the print medium by placing the last page normally printed on the document platen as the reading surface. After the completion of the reading, the controller 10 causes the user to be urged through the UI unit 30 to return the print medium (first print medium) on the document platen to the paper discharge unit again. According to this guidance, the user can collect the print medium from the document platen and return the print medium to the paper discharge unit again.

In addition, the controller 10 causes the user to be urged through the UI unit 30 to input the read start instruction by placing the second print medium on the document platen of the reading unit 60 by a process of the input control unit 11d such that the second print medium of which a surface already printed is the reading surface (corresponding to urging of input of second information). According to this guidance, the user can instruct the removing of the next print medium (second print medium) to be fed among the print media stacked in the paper feed unit of the print unit 50 from the paper feed unit, and the reading of the print medium by placing the print medium on the document platen. After the completion of the reading, a configuration may be adopted in which the controller 10 causes the user to be urged through the UI unit 30 to return the print medium (second print medium) on the document platen to the paper feed unit again by a process of the input control unit 11d. According to this guidance, the user can collect the print medium from the document platen and return the print medium to the paper feed unit again.

The read control unit ile is a program module for causing a function for generating medium image data to read the print medium on the document platen in the reading unit 60 in response to a reading start instruction to be realized in the controller 10. In this embodiment, two of the first print medium and the second print medium are read. By a process of the read control unit ile, the controller 10 performs reading of the reading unit 60 under a read condition corresponding to the feature information. For example, the controller 10 performs the reading at the “reading resolution” of the “feature information”. In addition, for example, in a case of a configuration in which the reading unit 60 includes a light source of three colors of RGB and controls lighting timings of the light sources of respective colors to perform reading of a color image, the reading may be performed by turning on only the light source of a color suitable for the reading of a “color” of the “feature information” at the time of reading of the first print medium and the second print medium.

In addition, the controller 10 performs the reading in a sub-scanning direction range corresponding to a region of the print medium on the document platen indicated by the “position” of the feature information, and does not perform the reading a range other than the range. By doing so, a time required for reading can be shortened as compared with a configuration in which the entire reading surface of the print medium is read.

For example, in a case where there are four patterns in directions of the print medium of for the document platen, each reading is performed in the sub-scanning direction range corresponding to the region of the print medium on the document platen indicated by the “position” in each pattern (region in consideration of rotation of print medium is read). As a first pattern among the four patterns, a state in which the short side of the print medium is parallel in the main scanning direction of the reading unit 60 and the print medium is placed to perform the reading in an order from the first short side toward the second short side, may be assumed. The second pattern, the third pattern, and the fourth pattern are in states in which the print media are rotated 90°, 180°, and 270° on the document platen from a case of the first pattern, respectively. In a case where the patterns of the rotation assumed based on the relationship of the sizes of the document platen and the print medium, are two patterns, the above-described first pattern and the third pattern may be assumed.

The setting unit 11f is a program module for causing a function for setting a normal print completion page P_{L} based on the feature of the print data of each page and the medium image data of the first print medium and a function for setting a print restart page P_{R} based on the feature of the print data of each page and the medium image data of the second print medium to be realized in the controller 10.

The setting of the normal print completion page P_{L} is made by specifying a page of the print data having a feature coinciding with the medium image data of the first print medium. For example, the second surface of the first print medium illustrated in FIG. 3 is read as the last page that is normally printed, in the last print medium that is normally printed. The controller 10 can specify that the page number of the print data having a feature coinciding with the medium image data indicating the second surface of the first print medium, is one, from the print management information 20a illustrated in FIG. 2. Therefore, in this case, the controller 10 sets one in the normal print completion page P_{L} by a process of the setting unit 11f.

The setting of the print restart page P_{R} is made by specifying a page of the print data having the feature coinciding with the medium image data of the second print medium and by specifying a page of the print data to be printed on the opposite surface of a surface on which the page is printed, in this embodiment. For example, it is assumed that the first surface of the fourth print medium illustrated in FIG. 3 is read as the print medium (second print medium) which can perform printing on the second surface after the occurrence of the print medium jam. The controller 10 can specify that the page number of the print data having the feature coinciding with the medium image data indicating the first surface of the fourth print medium, is eight, from the print management information 20a illustrated in FIG. 2. In addition, the controller 10 can specify that the print data of the seventh page is printed on the other surface of the print medium on which the print data of the eighth page is printed on one surface of the print medium, from the print management information 20a. Therefore, in this case, the controller 10 sets seven in the print restart page P_{R} by the process of the setting unit 11f.

Then, by a process of the print control unit 11a, the controller 10 restarts printing from the second print medium and performs printing from the print medium next to the first print medium to the print medium before the second print medium. That is, the controller 10 restarts the printing interrupted due to the print medium jam from the print restart page P_{R} in the print order. After completion of the printing to the last page in the print order, the controller 10 causes the printing to be performed again on the first surface and the second surface from the print medium on which the printing is performed on the page next to the normal print completion page P_{L} in the print order to the print medium on which the printing is performed on a page immediately before the print restart page P_{R} in the print order.

### 1-2: Print Control Process

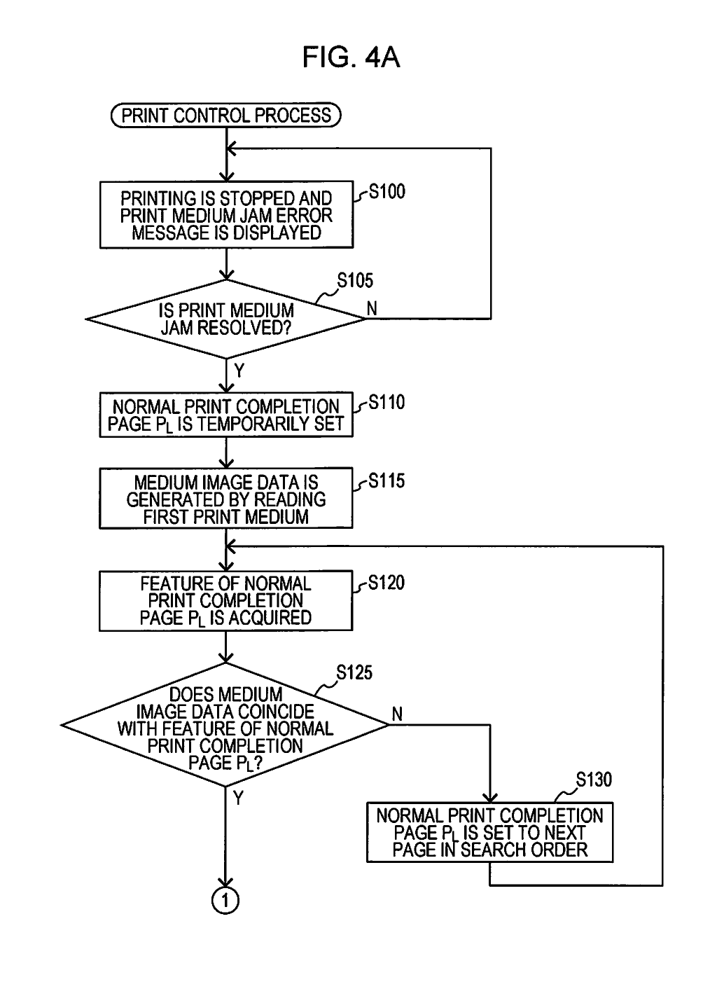

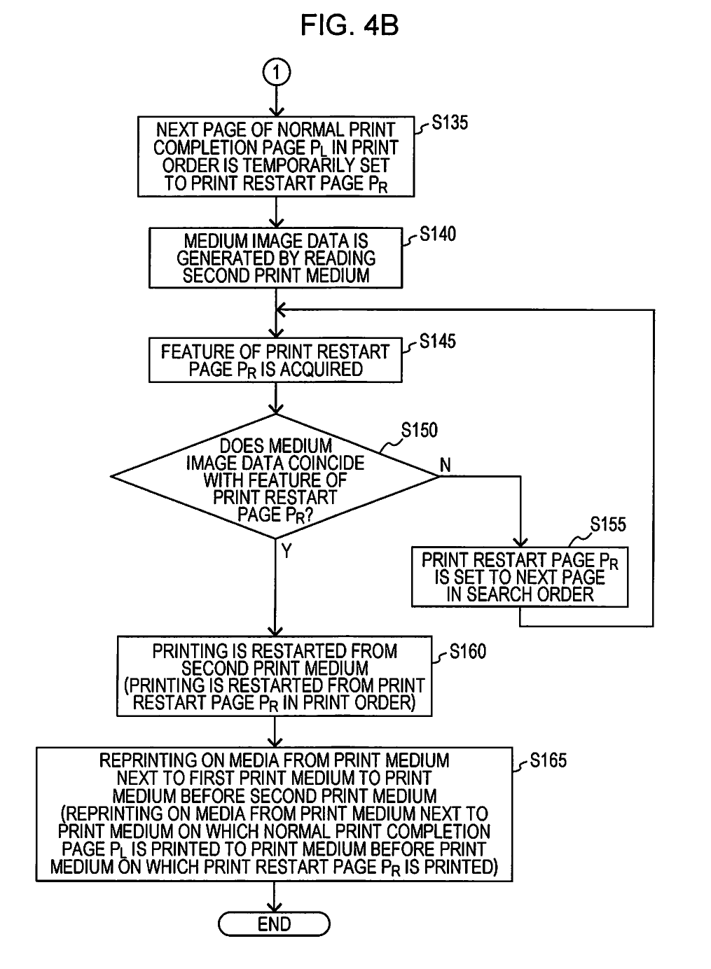

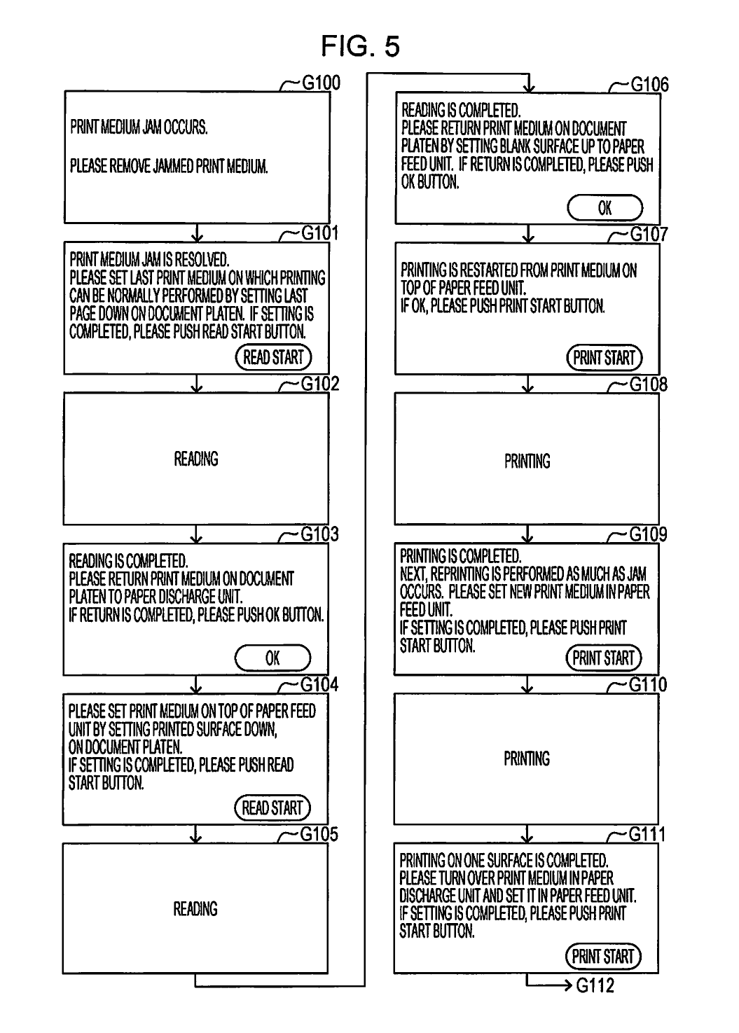

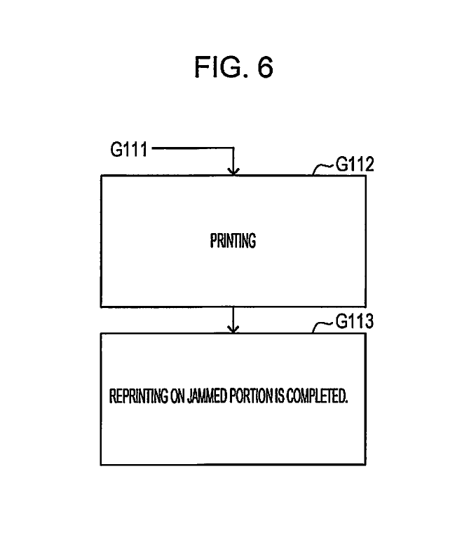

FIGS. 4A and 4B are a flowchart illustrating a print control process in a case where the print medium jam occurs while performing printing on the second surface after completion of printing on the first surface in the manual duplex printing. The process illustrated in FIGS. 4A and 4B is started in a case where the controller 10 acquires a signal indicating the occurrence of the print medium jam from the jam sensor while performing printing on the second surface in the manual duplex printing. When the print control process of FIGS. 4A and 4B is started, the controller 10 stops printing in the print unit 50, and causes to display a message indicating that a print medium jam error occurs on the UI unit 30 (step S100). In FIG. 5 and FIG. 6, display examples of a screen displayed on the UI unit 30 according to the performance of the print control process of FIGS. 4A and 4B, are illustrated. A screen G100 of FIG. 5 illustrates an example of a screen displayed in step S100. In the message indicated in step S100, a guide text explaining how to remove the jammed print medium may be included.

When the user removes the jammed print medium, the jam sensor outputs a signal indicating that the print medium jam is resolved to the controller 10. The controller 10 determines whether or not the print medium jam is resolved based on the signal output from the jam sensor (step S105). In a case where it is determined that the print medium jam is not resolved in step S105, the controller 10 causes the process to be returned to step S100 and continues to display an error message.

In a case where it is determined that the print medium jam is resolved in step S105, the controller 10 temporarily sets the normal print completion page P_{L} by the process of the setting unit 11f (step S110). For example, the controller 10 temporarily sets the number of a page being printed at the time of stopping printing in step S100 in the normal print completion page P_{L}.

Subsequently, the controller 10 generates the medium image data by reading the first print medium (step S115). Specifically, for example, as illustrated on a screen G101 of FIG. 5, by a process of the input control unit 11d, the controller 10 causes a message for urging the reading of the last print medium that is normally printed (first print medium) to be displayed on the UI unit 30. When the user acquires the last print medium that is normally printed from the paper discharge unit, places the acquired result on the document platen, and inputs the instruction of reading start, the controller 10 generates the medium image data by reading a document placed on the document platen by a process of the read control unit 11e. The controller 10 causes the reading to be performed under a reading condition according to the above-described feature information.

After the completion of the reading and the generation of the medium image data via a screen G102 indicating that the medium image data being generated, as illustrated on a screen G103, the controller 10 causes a message for urging to return the print medium on the document platen to the paper discharge unit to be displayed on the UI unit 30.

Then, the controller 10 acquires the feature information of the normal print completion page P_{L} from the storage unit 20 (step S120). In a case where step S120 is performed for the first time after the start of the print control process of FIGS. 4A and 4B, the feature information of the normal print completion page P_{L} temporarily set in step S110 is acquired in step S120. In a case where step S120 is performed for the second time after the start of the print control process of FIGS. 4A and 4B, the feature information of the normal print completion page P_{L} set in step S130 (which will be described below) is acquired.

Then, the controller 10 determines whether or not the medium image data coincides with the feature of the normal print completion page P_{L} (step S125). Specifically, for example, the controller 10 specifies a character or a number corresponding to the page identification information included in the medium image data. The controller 10 determines whether or not the feature information of the specified page identification information coincides with the “page identification information” in the feature information of the P_{L} page or the color of the character or the number corresponding to the specified page identification information coincides with the “color” in the feature information of the P_{L} page. In a case where they all match, Y determination is made in step S125.

In a case of N determination in step S125, the controller 10 sets the normal print completion page P_{L} to the next page in a search order by the process of the setting unit 11f(step S130), and returns the process to step S120. Specifically, the controller 10 sets a reverse order of the print order from a page set in step S110 as the search order. For example, in a case where the normal print completion page P_{L} temporarily set in step S120 is the third page, setting is performed in the order of the first page, the eighth page, the sixth page, the fourth page, and the second page in step S130.

In a case of Y determination in step S125, the controller 10 temporarily sets the page next to the normal print completion page P_{L} in the print order as the print restart page P_{R} by the process of the setting unit 11f (step S135). In a case where Y determination in step S125, this means that the page number set in the normal print completion page P_{L} at that time is set as a normal print completion page (normal setting not temporary setting).

Then, the controller 10 generates the medium image data by reading the second print medium (step S140). Specifically, for example, the controller 10 causes a message, as illustrated on the screen G104 of FIG. 5, to be displayed on the UI unit 30 by the process of the input control unit 11d in accordance with the pressing of an OK button on the screen G103 of FIG. 5. The screen G104 includes a message for urging the reading of the print medium (second print medium) next to the print medium damaged due to the print medium jam to the user. When the user acquires the print medium corresponding to the second print medium from the paper feed unit, places the acquired print medium on the document platen, and inputs the instruction of the reading start, the controller 10 generates the medium image data by reading the document placed on the document platen by the process of the read control unit 11e. During the reading and the generation of the medium image data, the controller 10 causes, for example, a screen G105 to be displayed. After the completion of the reading and the generation of the medium image data, for example, as illustrated on a screen G106, the controller 10 causes a message for urging the print medium on the document platen to return to the paper feed unit to be displayed on the UI unit 30.

Then, the controller 10 acquires the feature information of the print restart page P_{R} from the storage unit 20 (step S145). In a case where step S145 is performed for the first time after the start of the print control process of FIGS. 4A and 4B, the feature information of the print restart page P_{R} temporarily set in step S135 is acquired in step S145. In a case where step S145 is performed for the second time after the start of the print control process of FIGS. 4A and 4B, the feature information of the print restart page P_{R} set in step S155 (which will be described below) is acquired.

Then, the controller 10 determines whether or not the medium image data coincides with the feature of the print restart page P_{R} (step S150). The controller 10 specifies a character or a number corresponding to the page identification information included in the medium image data. The controller 10 determines whether or not the specified page identification information coincides with the “page identification information” in the feature information of the P_{L} page or the color of the character or the number corresponding to the specified page identification information coincides with the “color” in the feature information of the P_{R} page. In a case where they all match, Y determination is made in step S150.

In a case of N determination in step S150, by the process of the setting unit 11f, the controller 10 processes the print restart page P_{R} as a next page in the search order (step S155), and returns the process to step S145. Specifically, the controller 10 causes the print order to be set from a page set in step S135 as the search order. For example, in a case where the print restart page P_{R} temporarily set in step S135 is the third page, setting is performed in an order of the fifth page and the seventh page in step S130.

In a case of Y determination in step S150, the controller 10 causes printing to be restarted on the second surface from the second print medium by a process of the print control unit 11a(step S160). Specifically, in accordance with the pressing of the OK button on a screen G106, the controller 10 causes a message for urging print restart to be displayed on the UI unit 30 as illustrated on a screen G107. In accordance with the pressing of a print start button on the screen G107, the controller 10 causes the print data of the print restart page P_{R} to be printed on the second surface of the second print medium. Then, the controller 10 causes the print data of the page next to the print restart page P_{R} in the print order to be printed on the second surface of the print medium next to the second print medium. Hereinafter, the controller 10 performs the same print process until the last page in the print order. For example, during the printing, the controller 10 causes a screen G108 to be displayed on the UI unit 30. For example, as illustrated on a screen G109, when completing the printing from the print restart page P_{R} to the last page in the print order, the controller 10 causes a message for urging the user the print medium with front and back surfaces not printed to be set in the paper feed unit and urging the user to input a print start instruction after setting to be displayed on the UI unit 30.

In accordance with the pressing of the print start button on a screen G109, the controller 10 causes printing to be performed from the print medium next to the first print medium to the print medium before the second print medium by a process of the print control unit 11a (step S165). Specifically, the controller 10 specifies how many sheets of media is specified, corresponds to each of the print medium next to the first print medium (reprint top print medium) and the print medium before the second print medium (reprint end print medium). Then, the print data of a page to be printed on the first surface is printed on the first surface of the print medium newly set in each of the media from the reprint top print medium to the reprint end print medium. The controller 10 causes, for example, a screen G110 to be displayed on the UI unit 30 during printing.

For example, as illustrated on a screen G111, when completing the printing on the first surface of media from the reprint top print medium to the reprint end print medium, the controller 10 causes a message for urging an instruction of the print start for separating those print media on which the first surface is printed from the paper discharge unit, turning over those print media, and setting the print media in the paper feed unit, to be displayed on the UI unit 30. In accordance with the print start instruction of the user, the controller 10 causes the print data of a page to be printed on the second surface of each of media from the reprint top print medium to the reprint end print medium, to be printed on the print medium on which the first surface set in the paper feed unit is already printed. During the printing, the controller 10 causes a screen G112 of FIG. 6 to be displayed. For example, as illustrated on a screen G113 of FIG. 6, when printing is completed on the second surface of media from the reprint top print medium to the reprint end print medium, the controller 10 causes a message for informing that reprinting on both surfaces is completed by replacing the print medium damaged due to the print medium jam with a new print medium to be displayed on the UI unit 30.

Next, an operation example of a case where printing is completed on the first surface of four sheets of the print media, the print medium jam occurs during printing of the print data of the third page on the second surface of two sheets of the print media while printing on the second surface, and the third print medium starts to be transported from the paper feed unit, will be described. The user is urged by a message on the screen G100, and removes the jammed second print medium and the third print medium being transported. When the print medium jam is resolved, “three” is temporarily set in the normal print completion page P_{L} in step S110. Then, by urging the user with the message of the screen G101 (FIG. 5), the user reads the second surface (that is, first page) of the first print medium by the reading unit 60. The controller 10 sets “one” in the normal print completion page P_{L} based on the medium image data generated by the reading and the feature information of the print management information 20a (via steps S120 to S130).

In step S135, “three” which is the page next to the first page (normal print completion page P_{L}) in the print order is temporarily set in the print restart page P_{R}. The user urged by a message of the screen G104 reads the first surface (that is, eighth page) of the fourth print medium remaining in the paper feed unit in the reading unit 60. The controller 10 sets “seven” in the print restart page P_{R} based on the medium image data generated by the reading and the feature information of the print management information 20a (via steps S145 to S155).

In step S160, the print data of the seventh page is printed on the second surface of the fourth print medium. In addition, the print medium next to the print medium on which the normal print completion page P_{L} is printed, is the second print medium. In addition, the print medium before the print medium on which the print restart page P_{R} is printed, is the third print medium. Therefore, in step S165, after the print data of the fourth page and the sixth page are printed on the first surfaces of the second and third print media, the print data of the third page and the fifth page are printed on the second surfaces of the second and third print media.

As described above, in a case of this embodiment, in order for the printing apparatus to specify the print restart page, a configuration is adopted in which the user sets the second print medium on the document platen and inputs a reading instruction. Therefore, the user does not need to know the number of the print restart page. Accordingly, the user can easily cause the print device to restart printing from a page on which printing is restarted. In addition, in a case of this embodiment, it is possible to perform the printing of a page to be printed on the print medium damaged by the print medium jam. Also, when a page to be printed is designated, in a case of this embodiment, the user may perform the operation to read the first print medium and the second print medium, and the user does not need to know the number of the page itself. Therefore, the user can easily perform printing again.

A configuration may be adopted in which printing is restarted from the second print medium after printing from the print medium next to the first print medium to the print medium before the second print medium. That is, a process of step S165 illustrated in FIGS. 4A and 4B may be performed before a process of step S160. Specifically, after the Y determination is made in step S150, printing may be performed in the order of the fourth page, the sixth page, the third page, the fifth page, and the seventh page.

### 2. Second Embodiment

In the first embodiment, although a configuration is adopted in which both the restart of the printing on the medium from the second print medium based on the second information and the printing from the print medium next to the first print medium to the print medium before the second print medium based on the first information and the second information are performed by a batch process, the print restart from the second print medium may be performed by the batch process. That is, step S115 to step S130 may be omitted in the print control process of FIGS. 4A and 4B. The printing from the print medium next to the first print medium to the print medium before the second print medium may be individually performed by the user.

### 3. Other Embodiments

The technical scope of the present invention is not limited to the above-described embodiment, and it is obvious that various modifications can be made within a scope not deviating from the gist of the present invention. For example, in the above embodiment, a control program is executed in the print device, but a part of the control program (for example, extraction unit and setting unit) may be executed by a host computer.

In addition, for example, the first information for specifying the first print medium may be the page number input by the user. In addition, the second information for specifying the second print medium may be the page number input by the user. Therefore, in this case, the input unit is realized by a touch panel display or the key input unit. In addition, an input control unit includes a configuration for urging input of the page number.

In the embodiment, although the duplex printing is described as an example in which the print medium is associated with the print data to be printed on the print medium, the present invention can be applied to printing other than the duplex printing. For example, in a case where another data (print medium unique data) overlapped on the first surface is printed (overprinting) for each of a plurality of print media on which print medium unique data is already printed on the first surface, the present invention can be also applied. In this case, the “feature of the print medium” means the feature of data already printed on the print medium. A configuration may be adopted in which the feature of data already printed on the print medium is extracted from data obtained by reading the first surface in a reading unit prior to the second printing on the first surface, and a configuration may be adopted in which the user manually inputs the print medium into the print device. The feature of data already printed on the first surface of the extracted i-th print medium and the print data to be performed (performed overlapping printing) on the second printing on the first surface of the i-th print medium in association with each other is stored in the storage unit. By adopting such a configuration, in a case where the print medium jam occurs during the overprinting on each of multiple sheets of the print media by the batch process, it is possible to easily perform the print restart or reprinting after resolution of the print medium jam.

The present invention can be applied to single-sided printing (different from print data to be printed on each print medium) on the plurality of print media other than the duplex printing or the overprinting. For example, in a case where the print medium jam occurs during the single-sided printing on the plurality of print media, the print device instructs the user to remove the jammed print medium, and instructs the user to perform the reading on the printed surface of the last print medium on which printing is normally completed. Then, the print device may specify the normal print completion page based on the medium image data generated by reading and the feature of the print medium (page identification information or the like extracted from print data to be printed on each print medium), set a page next to the normal print completion page as the print restart page, and restart printing from the print restart page. Also, even in this case, since it is not necessary for the user to check the number itself of the print restart page, it is possible to easily restart printing.

For example, if the “color” of the “page identification information” in the feature information is a color which can be read by only a specific color beam source among a plurality of color beam sources, reading performed by turning on only the beam source may be performed as one read condition. Specifically, for example, in a case where the page identification information is the red color, a configuration may be adopted in which the reading is performed by turning on only a beam source of one of G and B. In addition, for example, in a case where the “page identification information” in the feature information is printed at a resolution that can be read in the reading of a specific resolution, the read control unit may read the page identification information at a resolution that can be read.

In addition, the cause of interruption of printing may be a cause other than the print medium jam. For example, the leakage of the recording agent, insufficient fixing at a fixing unit, communication error with the host computer, a user operation, or the like may be used.

In addition, as long as the page identification information can identify a page, various aspects other than the examples mentioned in the above embodiment can be assumed. For example, the page identification information may include the page number, a chapter number, a security number, a serial number, a reference number, a name, a phone number, a figure, an image, or the like to be printed on the print medium. In addition, the page identification information is not limited to the one which can be checked with the naked eye by the user, but if the print device can be checked, it may be one, which cannot be checked by the user with the naked eye, such as watermark printing and printing with an ultraviolet reflection ink.

The entire disclosure of Japanese Patent Application No. 2017-201617, filed Oct. 18, 2017 is incorporated by reference herein.

What is claimed is:

1. A print device comprising:
a storage unit that stores feature of a print medium and print data of a page to be printed on the print medium in association with each other;
a reading unit that generates medium image data by reading the print medium which is already printed before interrupt of printing after the interrupt;
a setting unit that sets a print restart page based on the feature of the print medium and the medium image data; and
a print unit that performs printing based on the print data after the print restart page after resolving a cause of the interrupt of printing.

2. The print device according to claim 1, further comprising:
an extraction unit that extracts feature of the print data of a page printed on a first surface of a predetermined print medium and stores the feature of the print data of the page and the print data of a page to be printed on the second surface of the predetermined print medium in association with each other.

3. The print device according to claim 1,
wherein the reading unit performs reading under a read condition in accordance with the feature of the print medium.

4. The print device according to claim 1,
wherein the reading unit reads a region which is a part of the print medium and is taken in consideration of rotation of the medium image data according to the feature of the print medium.

5. A production method of a printed matter comprising:
storing feature of a print medium and print data of a page to be printed on the print medium in association with each other;
generating medium image data by reading the print medium which is already printed before interrupt of printing after the interrupt;
setting a print restart page based on the feature of the print medium and the medium image data; and
performing printing based on the print data after the print restart page after resolving a cause of the interrupt of printing.

6. A control program causing a computer to function as:
a storage control unit that stores feature of a print medium and print data of a page to be printed on the print medium in association with each other in a storage unit;
a read control unit that generates medium image data by reading the print medium which is already printed before interrupt of printing in a reading unit after the interrupt;
a setting unit that sets a print restart page based on the feature of the print medium and the medium image data; and
a print control unit that performs printing based on the print data after the print restart page in a print unit after resolving a cause of the interrupt of printing.

7. The print device according to claim 1,
wherein the setting unit specifies a second print medium which is a print medium next to the print medium damaged due to the interrupt of printing, and
the print unit performs duplex printing from the print medium of the print restart page to the print medium before the second print medium after a print medium jam is resolved.

8. The print device according to claim 7,
wherein the print unit restarts printing from the second print medium, and then performs the duplex printing from the print medium of the print restart page to the print medium before the second print medium, after print restart.

9. The print device according to claim 7,
wherein the print unit performs the duplex printing from the print medium of the print restart page to the print medium before the second print medium, and then restarts printing from the second print medium, after the print restart.
